(19) United States
(12) Patent Application Publication
(10) Pub. No.: US 2026/0209435 A1
(43) Pub. Date: Jul. 23, 2026

(54) OLIGOMER, METHOD FOR PREPARING OLIGOMER, AND METHOD FOR PREPARING CURED PRODUCT OF OLIGOMER

(71) Applicant: CPC CORPORATION, TAIWAN, Kaohsiung City (TW)

(72) Inventors: SHENG-DE LI, Zhubei City (TW); CHING-HSUAN LIN, Taichung City (TW); WEN-CHANG CHEN, Taipei City (TW); MENG-XUAN LI, Taichung City (TW); YI-CHENG WANG, Taichung City (TW); YI-CHUN CHEN, Taichung City (TW); LIN-CHIANG HUANG, Chia-Yi City (TW); JUI-FU KAO, Chia-Yi City (TW); MING-YU HUANG, Chia-Yi City (TW); JANN-CHEN LIN, Chia-Yi City (TW)

(73) Assignee: CPC CORPORATION, TAIWAN, Kaohsiung City (TW)

(21) Appl. No.: 19/077,055

(22) Filed: Mar. 12, 2025

(30) Foreign Application Priority Data
Jan. 23, 2025 (TW) 114103003

(51) Int. Cl. C08G 65/48; C08F 299/02; C08G 65/40

(52) U.S. Cl. CPC C08G 65/48; C08F 299/022; C08G 65/4081; C08G 65/4087

(57) ABSTRACT

An oligomer having a structure as shown in Formula (I):

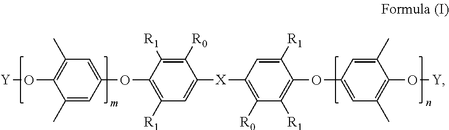

wherein, X is a structure of

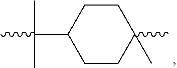

Y are each independently a structure of hydrogen, halogen,

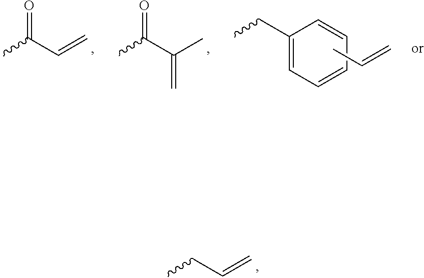

R₀ and R₁ are each independently a structure of hydrogen, C₁-C₆ alkyl, phenyl or

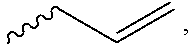

and n and m are each independently an integer from 0 to 300. The oligomer of the present invention is suitable for forming a cured product which can be used as a low dielectric resin material. The present invention also relates to a method for preparing an oligomer and a method for preparing a cured product of the oligomer.

### CROSS-REFERENCE TO RELATED APPLICATION

This non-provisional application claims priority under 35 U.S.C. § 119(a) on Patent Application No(s). 114103003 filed in Taiwan, R.O.C. on Jan. 23, 2025, the entire contents of which are hereby incorporated by reference.

### BACKGROUND OF THE INVENTION

### 1. Field of the Invention

The present disclosure relates to an oligomer, in particular to an oligomer having a structure as shown in Formula (I):

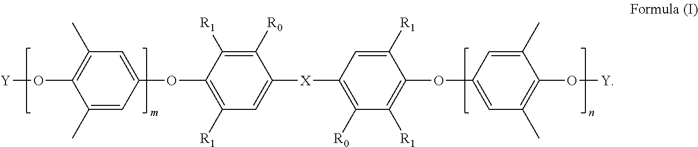

The present disclosure also relates to a method for preparing an oligomer and a method for preparing a cured product of the oligomer.

### 2. Description of the Related Art

In recent years, due to the intensification of global warming, countries around the world have raised their awareness of environmental protection and begun to pay attention to the carbon footprint and carbon emissions generated in the production process of products, many countries have successively formulated policies and regulations related to carbon credits, hoping to quantify carbon emissions and impose carbon taxes, so as to limit emissions and reduce the greenhouse effect.

Since the carbon footprint of bio-based materials is lower than that of petrochemical-based materials, they can continue to help reduce carbon dioxide emissions and reduce their impact on the environment. They are mostly produced by plants and are considered renewable resources. Therefore, the demand to replace traditional petroleum-based materials with low-carbon materials and bio-based materials has become the primary development direction of related industries.

On the other hand, with the evolution of the times, semiconductor technology continues to develop, the size of electronic components is increasingly reduced, and the spacing between metal wires is also reduced, resulting in signal interference between metal wirings. In addition, the influence between the wires and the dielectric layer can easily cause signal transmission delay, so the electrical properties of the resin layer will play an important role in the circuit board. The smaller the dielectric constant Dₖ and dielectric loss D_{f} of the dielectric layer, the better it is to reduce the signal loss during signal transmission and increase the transmission speed. Therefore, relevant industries are currently in urgent need of low-dielectric resin materials that meet the above requirements.

### BRIEF SUMMARY OF THE INVENTION

There is still room for improvement in traditional resin materials. Therefore, an object of the present disclosure is to provide a novel oligomer, which is suitable for forming a cured product that can be used as a low dielectric resin material.

Poly(2,6-dimethylphenyl ether) (PolyPhenyleneOxide, PPO) is one of the five major engineering plastics, which is an amorphous thermoplastic polymer, and has the characteristics of high molecular weight, rigid structure, high glass transfer temperature, impact resistance and low expansion coefficient, and because it does not have hydrolyzable bonds and polar functional groups, it has excellent electrical properties. However, the high molecular weight also results in high viscosity and poor solubility, which limits the application range of poly(2,6-dimethylphenyl ether).

In recent years, poly(2,6-dimethylphenyl ether) has been improved into (2,6-dimethylphenyl ether) oligomers, but the heat resistance is not good, so the ends need to be modified to form a cross-linkable end group structure. In view of this fact, the development of a bio-based (2,6-dimethylphenyl ether) oligomer with excellent performance, wide range of applications and simple preparation method has become the goal of related industries.

An object of the present disclosure is to provide a functionalized (2,6-dimethylphenyl ether) oligomer containing a bio-based material and derivatives thereof and a preparation method thereof, which has the effects of simplifying steps and reducing production costs.

Another object of the present disclosure is to provide a method for preparing a cured product of an oligomer, which is to carry out a curing reaction of the aforesaid oligomer to prepare a cured product, and the cured product has a low dielectric constant, low dielectric loss and preferable thermal stability.

In order to achieve the above objects and other objects, the present disclosure provides an oligomer, having a structure as shown in Formula (I):

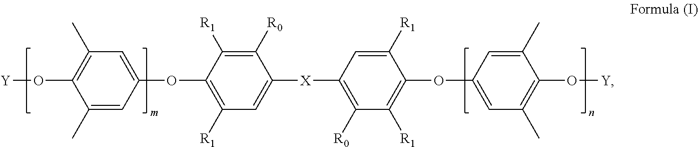

wherein, X is a structure of

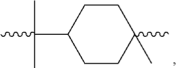

Y are each independently a structure of hydrogen, halogen,

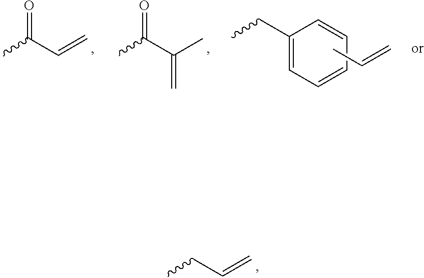

R₀ and R₁ are each independently a structure of hydrogen, C₁-C₆ alkyl, phenyl or

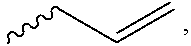

and n and m are each independently an integer from 0 to 300.

In one embodiment of the present disclosure, the oligomer may have a structure as shown in Formula (I-1), Formula (I-2), Formula (I-3) or Formula (I-4):

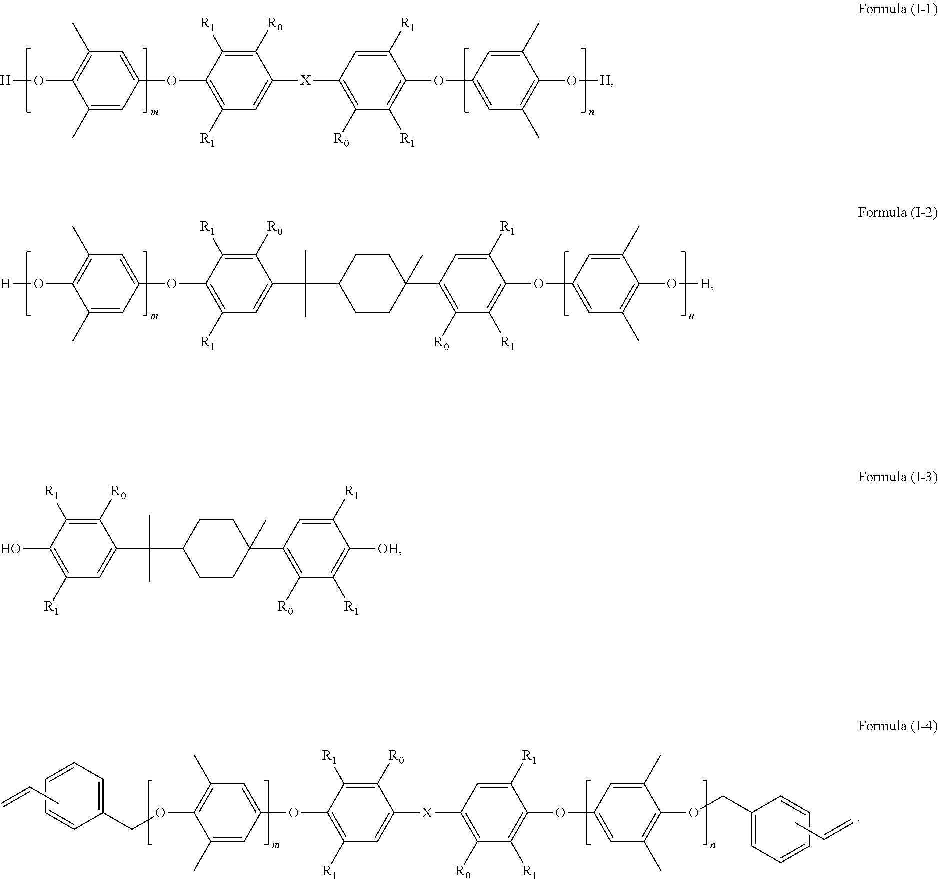

In order to achieve the above objects and other objects, the present disclosure also provides a method for preparing an oligomer, including the following steps:
(a) adding a bio-based diene compound and a phenolic compound in a Lewis acid catalyst, raising temperature to 80-150° C., and stirring to allow them to react, washing with water after synthesis and neutralizing and purifying to obtain a phenolic reactant;
(b) mixing the phenolic reactant obtained in step (a) with 2,6-xylenol in a co-solvent of methanol and water containing a copper catalyst and an amine catalyst, and carrying out oxidative polymerization in an oxygen environment and at a temperature of 0-70° C. to obtain a bisphenol polyphenylene ether oligomer; and
(c) allowing the bisphenol polyphenylene ether oligomer obtained in step (b) to react with methacrylic anhydride or vinyl benzyl halide at a temperature of 45-100° C. under the catalysis of an alkali catalyst to obtain the oligomer.

In one embodiment of the present disclosure, a molar ratio of the bio-based diene compound and the phenolic compound in step (a) may be 1:2-1:10, and a molar ratio of the phenolic reactant and the 2,6-xylenol in step (b) may be 1:2-1:10.

In one embodiment of the present disclosure, the bio-based diene compound in step (a) may be selected from the group consisting of

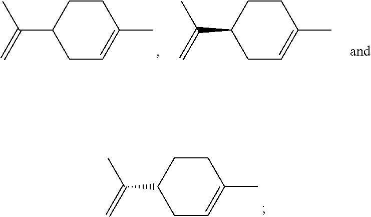

the phenolic compound may be selected from the group consisting of phenol, 2,6-xylenol and 2,3,6-trimethylphenol; and the Lewis acid catalyst may be selected from the group consisting of BF₃ and halogen aluminide.

In one embodiment of the present disclosure, in step (b), the copper catalyst may be selected from the group consisting of CuCl, CuCl₂, CuBr and CuBr₂; and the amine catalyst may be selected from the group consisting of (trialkyl)amine and dialkylamino pyridine, wherein alkyl groups are each independently a structure of C₁-C₆ alkyl.

In one embodiment of the present disclosure, in step (b), the oxygen source of the oxygen environment may be pure oxygen or air.

In order to achieve the above objects and other objects, the present disclosure also provides a method for preparing a cured product of an oligomer, comprising the following steps:
(a) taking the oligomer prepared by the above preparation method; and
(b) carrying out copolymerization of the oligomer with peroxide to obtain a cured product of the oligomer.

In one embodiment of the present disclosure, in step (b), the peroxide may be selected from the group consisting of benzoyl peroxide and cumene tert-butyl peroxide.

In one embodiment of the present disclosure, in step (b), the content of the peroxide may be 0.1 wt % to 1.0 wt % in the total weight of the oligomer and the peroxide.

The oligomer of the present disclosure can form a cured product with excellent dielectric properties by virtue of the unique molecular structure, so that the cured product can be used as a low-dielectric resin material for the semiconductor industry. The method for preparing the oligomer of the present disclosure can form the oligomer described above by using a bio-based diene compound, and can effectively reduce the carbon footprint. The method for preparing the cured product of the oligomer of the present disclosure can form a cured product with excellent dielectric properties by the oligomer prepared by the above-mentioned method, so that the cured product can be used as a low-dielectric resin material for the semiconductor industry.

### BRIEF DESCRIPTION OF THE DRAWINGS

None

### DETAILED DESCRIPTION OF THE INVENTION

To facilitate understanding of the purpose, characteristics and effects of the present disclosure, examples together with the attached drawings for the detailed description of the present disclosure are provided as below.

### Examples 1-4

### Example 1, Preparation of Bisphenol Monomer (LN-Core)

2,6-dimethylphenol 30.8 g (0.12*2.1 mole) and aluminum chloride (AlCl₃) 2.67 g (0.12*0.17 mole) are taken and placed in a 250 ml single-neck flask and stirred at 80° C. for about 30 minutes, at this time, it is a red-black transparent solution. Then, (±)-limonene 16.3 g (0.12 mole) is weighed and slowly dropped into the solution and the reaction is continued for three hours, after the reaction, 25 g of 10 wt % sodium hydroxide aqueous solution (NaOH_{(aq)}) is added dropwise and stirred for about 1 hour to neutralize the catalyst to stop the reaction. After the reaction is completed, the solution is dissolved in toluene and extracted with water several times, and toluene and excess 2,6-dimethylphenol are removed by vacuum distillation to obtain a brown solid. The reaction equation of Example 1 is shown in Table 1 below.

TABLE 1

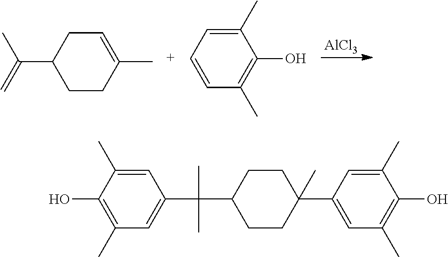

### Example 2, Preparation of Bisphenol Oligomer (LN-OPE)

Copper(I) chloride 2.7 g (0.092*0.3 mole) and 4-dimethylaminopyridine (DMAP) 18 g (0.092*1.65 mole) are taken and dissolved in 300 ml methanol and placed in a 1000 ml three-neck flask, oxygen is introduced under the liquid surface and stirred for about 30 minutes. At the same time, 35.1 g (0.092 mole) of bisphenol monomer (LN-core) obtained in Example 1 and 90 g (0.092*8 mole) of 2,6-dimethylphenol are dissolved in 450 ml of methanol and poured into the aforesaid copper catalyst solution, and oxygen is introduced to continue the reaction for eight hours. After the reaction is completed, the solution is filtered directly, the filter cake is taken and it is washed twice with 2 L methanol containing 10 ml HCl, and then washed with methanol several times to obtain a brown powder. The reaction equation of Example 2 is shown in Table 2 below.

TABLE 2

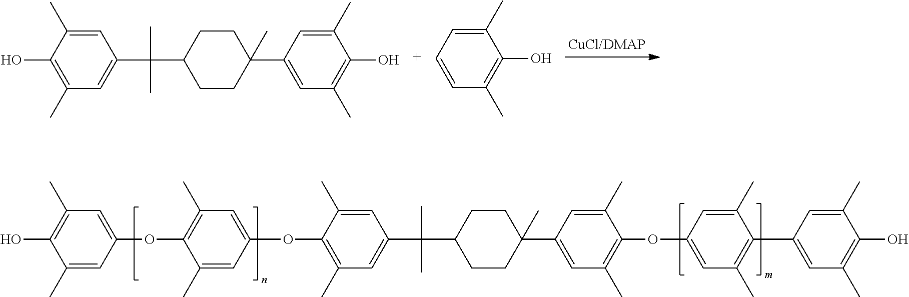

### Example 3, Preparation of Oligomer (LN-OPE-PM)

5.00 g (3.125 mmol) of bisphenol oligomer (LN-OPE) prepared in Example 2, 1.93 g (3.125*4 mmol) of methacrylic anhydride and sodium acetate (AcONa) 0.1 g (2 wt % of LN-OPE) are taken and dissolved in 50 ml dimethylacetamide (DMAc) and placed in a 100 ml three-neck flask, the temperature is raised to 80° C. and nitrogen is introduced to carry out the reaction for 24 hours. After the reaction is completed, the solution is poured into methanol/water co-solvent (v:v/4:1) for precipitation, and after washing several times, the filter cake is taken and dried in a 78° C. oven to obtain a light gray powder, in order to obtain a (2,6-dimethylphenyl ether) oligomer of the methyl acrylic group at the end of Example 3. The reaction equation of Example 3 is shown in Table 3 below.

TABLE 3

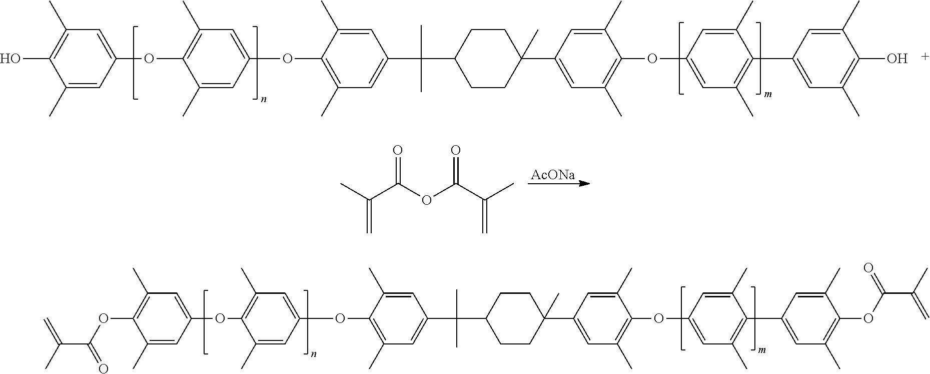

### Example 4, Preparation of Oligomer (LN-OPE-VB)

5.00 g of bisphenol oligomer (LN-OPE) prepared in Example 2, 1.43 g (3.125*3 mmol) of 4-(chloromethyl)styrene, and 1.29 g (3.125*3 mmol) of potassium carbonate (K₂CO₃) are taken and dissolved in 50 ml dimethylacetamide (DMAc), and placed in a 100 ml three-neck flask, and the temperature is raised to 80° C. and nitrogen is introduced to carry out for 24 hours. After the reaction is completed, the solution is poured into methanol/water co-solvent (v:v/4:1) for precipitation, and after washing several times, the filter cake is taken and dried in a 78° C. oven to obtain a light gray powder, in order to obtain a (2,6-dimethylphenyl ether) oligomer containing styrene at the end of Example 4. The reaction equation for Example 4 is shown in Table 4 below.

TABLE 4

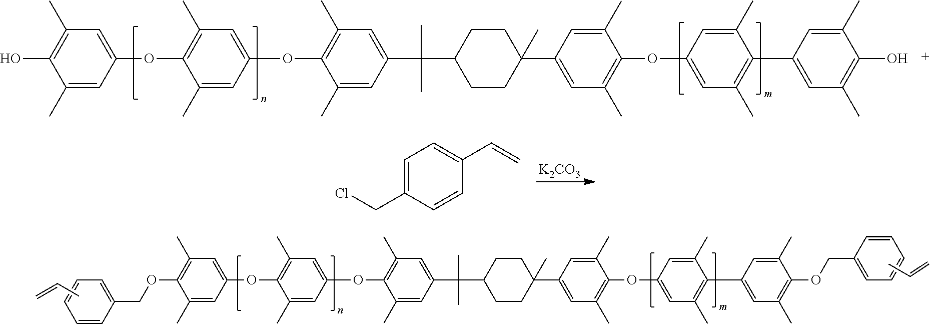

### Examples 5-6

### Example 5, Cured Product of Oligomer (LN-OPE-PM)

The oligomer (LN-OPE-PM) prepared in Example 3 is mixed with a free radical initiator of dicumyl peroxide (DCP), and then prepared into a solution with a solid content of 20% with xylene, wherein the content of DCP is 1.0 weight percentage of the oligomer. Next, after mixing evenly, the solution is poured into a mold, and raised temperature and cured in a nitrogen environment, and the temperature rising conditions are 80° C. (8 hours), 120° C. (2 hours), 140° C. (2 hours), 180° C. (2 hours), 200° C. (2 hours), 220° C. (2 hours). After demoulding, a cured product of the oligomer (LN-OPE-PM) of Example 3 can be obtained.

### Example 6, Cured Product of Oligomer (LN-OPE-VB)

The same preparation process as in Example 5 is used, but the oligomer (LN-OPE-PM) prepared in Example 3 is replaced with the oligomer (LN-OPE-VB) prepared in Example 4 to obtain a cured product of the oligomer (LN-OPE-VB) in Example 4.

### Comparative Examples 1-2

### Comparative Example 1, Preparation of Cured Product of SA9000

Product SA9000 of Saudi Basic Industries Corporation (SABIC) is prepared into a solution with a solid content of 20 wt % with xylene, and 1.0 weight percentage dicumyl peroxide (DCP) of SA9000 is added, poured into a mold, and raised temperature and cured in a nitrogen environment, and the temperature rising conditions are 80° C. (8 hours), 120° C. (2 hours), 140° C. (2 hours), 180° C. (2 hours), 200° C. (2 hours), 220° C. (2 hours). After demoulding, a cured product C-SA-9000 of Comparative example 1 can be obtained.

### Comparative Example 2, Preparation of Cured Product of OPE-2st

Product OPE-2st of Mitsubishi Gas Chemical Company is prepared into a solution with a solid content of 20 wt % with xylene, and 1.0 weight percentage dicumyl peroxide (DCP) of OPE-2st is added, poured into a mold, and raised temperature and cured in a nitrogen environment, and the temperature rising conditions are 80° C. (8 hours), 120° C. (2 hours), 140° C. (2 hours), 180° C. (2 hours), 200° C. (2 hours), 220° C. (2 hours). After demoulding, a cured product C-OPE-2st of Comparative example 2 can be obtained.

### Test Example 1: Evaluation of the Thermal Properties of Each Cured Product

(1) Dynamic Mechanical Analyzer (DMA) is used to measure the storage modulus and Tan delta curves as a function of temperature and the glass transfer temperature (Tg) of the cured products, wherein the temperature rise rate is 5° C./min and the temperature range is 40° C. to 300° C.
(2) Thermomechanical Analysis (TMA) is used to measure the glass transfer temperature and coefficient of thermal expansion (CTE) of the cured products, wherein the temperature rise rate is 5° C./min and the temperature range is 50° C. to 150° C.
(3) Thermogravimetric analysis (TGA) is used to measure the 5% thermogravimetric loss temperature (Tds %) and the char yield at 800° C. of the cured products. The conditions for thermogravimetric analysis are to use a thermogravimetric analyzer to measure the weight change of the sample under a nitrogen atmosphere at a temperature rise rate of 20° C./min. The 5% thermogravimetric loss temperature refers to the temperature at which the weight loss of the sample reaches 5%, wherein the higher the 5% thermogravimetric loss temperature, the better the thermal stability of the sample. The char yield at 800° C. refers to the residual weight ratio of the sample when the heating temperature reaches 800° C., wherein the higher the residual weight ratio at 800° C., the better the thermal stability of the sample.

The results of the thermal property evaluation of each cured product of Example 5 and Example 6 and Comparative example 1 and Comparative example 2 are shown in Table 5 below:

TABLE 5

| Cured | T_{g} | T_{g} | | | Char |
|---|---|---|---|---|---|
| product | (° C.) | (° C.) | CTE | T_{d5%} | yield |
| composition | (DMA) | (TMA) | (ppm/° C.) | (° C.) | (%) |
| Example 5 | 228.1 | 193.4 | 80.4 | 477.9 | 20.4 |
| (Cured | | | | | |
| product of | | | | | |
| LN-OPE-PM) | | | | | |
| Example 6 | 216.5 | 192.1 | 78.5 | 365.7 | 21.9 |
| (Cured | | | | | |
| product of | | | | | |
| LN-OPE-VB) | | | | | |
| Comparative | 228.4 | 197.9 | 61.4 | 476.9 | 21.5 |
| example 1 | | | | | |
| Comparative | 221.9 | 186.8 | 66.1 | 384.5 | 23.5 |
| example 2 | | | | | |

### Test Example 2: Evaluation of the Electrical Properties of Each Cured Product at 10 GHz

The cured products of Example 5 and Example 6 and Comparative example 1 and Comparative example 2 are evaluated for electrical properties, and the evaluation method is to measure the dielectric constant and the dielectric loss of the cured film at 10 GHz with a dielectric constant meter. The results of the electrical property evaluation of the cured products of Example 5 and Example 6 and Comparative example 1 and Comparative example 2 are shown in Table 6 below.

TABLE 6

| Cured product | Dielectric | Dielectric |
|---|---|---|
| composition | constant Dₖ | loss D_{f} |
| Example 5 | 2.59 ± 0.069 | 0.0031 ± 0.0004 |
| (Cured product | | |
| of LN-OPE-PM) | | |
| Example 6 | 2.63 ± 0.052 | 0.0039 ± 0.0002 |
| (Cured product | | |
| of LN-OPE-VB) | | |
| Comparative example 1 | 2.64 ± 0.048 | 0.0030 ± 0.0003 |
| Comparative example 2 | 2.75 ± 0.060 | 0.0043 ± 0.0005 |

As shown in Table 5 and Table 6, the present disclosure introduces a bio-based structure into the (2,6-dimethylphenyl ether) oligomer, which can reduce the use of petroleum-based raw materials to meet the needs of low-carbon development in the future, and carries out unsaturated functionalization at the end, so that the cured product formed by it has good glass transfer temperature, thermal stability and excellent electrical properties, and meets the current demand for high-frequency communication substrate material resin. In addition to being a high-frequency communication substrate material resin, the oligomer of the present disclosure can also be used in the fields of high-temperature additives, coating materials and adhesives, and the like.

While the present invention has been described by means of preferable examples, those skilled in the art should understand the above description is merely examples of the invention, and it should not be considered to limit the scope of the invention. It should be noted that all changes and substitutions which come within the meaning and range of equivalency of the examples are intended to be embraced in the scope of the invention. Therefore, the scope of the invention is defined by the claims.

While the present disclosure has been described by means of specific embodiments, numerous modifications and variations could be made thereto by those skilled in the art without departing from the scope and spirit of the present disclosure set forth in the claims.

What is claimed is:

1. An oligomer, having a structure as shown in Formula (I): 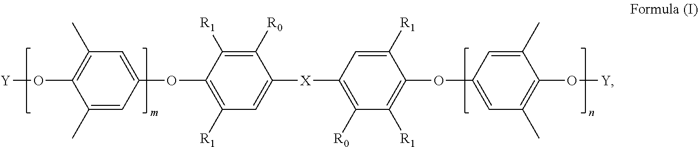
wherein, X is a structure of 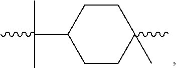
Y are each independently a structure of hydrogen, halogen, 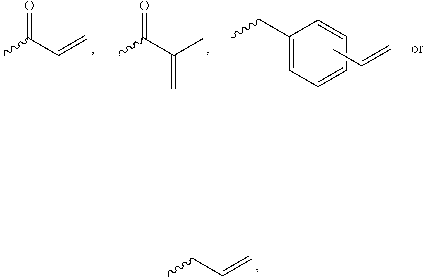
R₀ and R₁ are each independently a structure of hydrogen, C₁-C₆ alkyl, phenyl or 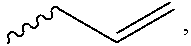
and n and m are each independently an integer from 0 to 300.

2. The oligomer according to claim 1, having a structure as shown in Formula (I-1), Formula (I-2), Formula (I-3) or Formula (I-4):

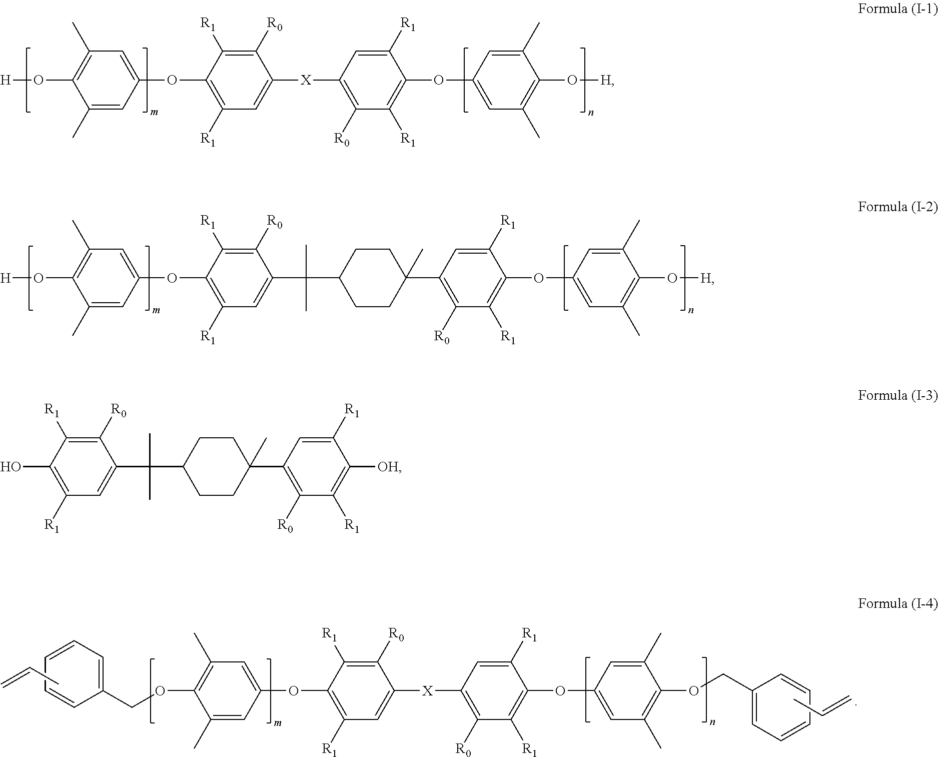

3. A method for preparing an oligomer, comprising the following steps:
(a) adding a bio-based diene compound and a phenolic compound in a Lewis acid catalyst, raising temperature to 80-150° C., and stirring to allow them to react, washing with water after synthesis and neutralizing and purifying to obtain a phenolic reactant;
(b) mixing the phenolic reactant obtained in step (a) with 2,6-xylenol in a co-solvent of methanol and water containing a copper catalyst and an amine catalyst, and carrying out oxidative polymerization in an oxygen environment and at a temperature of 0-70° C. to obtain a bisphenol polyphenylene ether oligomer; and
(c) allowing the bisphenol polyphenylene ether oligomer obtained in step (b) to react with methacrylic anhydride or vinyl benzyl halide at a temperature of 45-100° C. under the catalysis of an alkali catalyst to obtain the oligomer.

4. The preparation method according to claim 3, wherein a molar ratio of the bio-based diene compound and the phenolic compound in step (a) is 1:2-1:10, and a molar ratio of the phenolic reactant and the 2,6-xylenol in step (b) is 1:2-1:10.

5. The preparation method according to claim 3, wherein the bio-based diene compound in step (a) is selected from the group consisting of 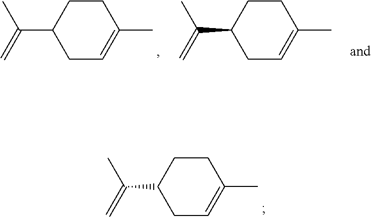
the phenolic compound is selected from the group consisting of phenol, 2,6-xylenol and 2,3,6-trimethylphenol; and the Lewis acid catalyst is selected from the group consisting of BF₃ and halogen aluminide.

6. The preparation method according to claim 3, wherein in step (b), the copper catalyst is selected from the group consisting of CuCl, CuCl₂, CuBr and CuBr₂; and the amine catalyst is selected from the group consisting of (trialkyl)amine and dialkylamino pyridine, wherein alkyl groups are each independently a structure of C₁-C₆ alkyl.

7. The preparation method according to claim 3, wherein in step (b), the oxygen source of the oxygen environment is pure oxygen or air.

8. A method for preparing a cured product of an oligomer, comprising the following steps:
(a) taking the oligomer prepared by the preparation method according to claim 3; and
(b) carrying out copolymerization of the oligomer with peroxide to obtain a cured product of the oligomer.

9. The preparation method according to claim 8, wherein in step (b), the peroxide is selected from the group consisting of benzoyl peroxide and cumene tert-butyl peroxide.

10. The preparation method according to claim 8, wherein in step (b), the content of the peroxide is 0.1 wt % to 1.0 wt % in the total weight of the oligomer and the peroxide.
